(19) United States
(12) Patent Application Publication
(10) Pub. No.: US 2003/0004877 A1
(43) Pub. Date: Jan. 2, 2003

(54) Transaction terminal apparatus

(75) Inventor: Takami Kasasaku, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/102,691

(22) Filed: Mar. 22, 2002

(30) Foreign Application Priority Data
Jun. 27, 2001 (JP) 2001-195270

(51) Int. Cl. G06F 17/60

(52) U.S. Cl. 705/41

(57) ABSTRACT

The present invention is constituted so that the elements required to be tamperproof, from among the structural elements of the transaction terminal apparatus for executing transaction processing with a customer, are constituted as a module that is removable from the main body of the transaction terminal apparatus and the module is constituted so as to be tamperproof. In this way, the main body of the transaction terminal apparatus does not need to be made tamperproof because the elements required to be tamperproof are made modular and removed from the main body. The application programs relating to various types of transactions stored in the main body can be easily added to, modified, revised, and updated, and the versatility and expandability are improved.

### BACKGROUND OF THE INVENTION

1. Field of the Invention

The present invention relates to a transaction terminal apparatus for executing transactions with customers, and more particularly to a transaction terminal apparatus which is tamperproof and has a function for preventing the leakage of secret information.

2. Description of the Related Art

Transaction terminal apparatuses used in settlement by credit card and debit card settlement using bank cash cards were known before now.

FIG. 7 is a simple block diagram of the constitution of a conventional transaction terminal apparatus having a settlement function. In FIG. 7, the transaction terminal apparatus (sometimes referred to as simply a “transaction terminal”) is a portable terminal, for example, and comprises: a display unit 10 such as a liquid crystal, ROM 11 for storing the settlement program, encryption program, and so forth, RAM 12 for storing temporary data, a CPU 13 for executing the settlement program, a card reader 14 for reading card information including the card number of a credit card or cash card, a keyboard 15 for the customer to input the personal identification number (PIN), and a line unit 16 for carrying out communication through a telecommunications network with a prescribed settlement server. That line unit 16 sends the personal identification number and card information encrypted by the encryption program stored in the ROM 11 to the settlement server. The settlement server is a host computer of a bank or credit card company, for example, and decrypts the encrypted card number and personal identification number from the transaction terminal, verifies those, carries out a credit confirmation process or the like for determining the settlement authorization, and returns the prescribed response data to the transaction terminal. In the transaction terminal, the CPU 13 executes the settlement program and carries out the settlement process for that response data.

In this type of transaction terminal, it is necessary to prevent the fraudulent access to personal information such as the personal identification number input from the keyboard 15 and the card information read from the card reader 14, and to secure the secrecy thereof. In other words, tamper-proofing is required so that the personal identification number and card information itself, and the encryption program and so forth for these be made not stealable by some means. Tamper-proofing is the capacity to prevent the leakage of secret information from fraudulent access by opening the case of the transaction terminal. Tamper-proofing is realized, for example, by making it impossible to steal signals from the wiring by affixing the wiring with resin, or by adding a function for destroying the contents of the ROM 11 and RAM 12 therein when it is detected by prescribed detecting means that the case of the terminal is opened.

For this reason, in the prior art, it was necessary to provide a tamperproof structure to the entire transaction terminal, and to develop the transaction terminal having a settlement function as a dedicated device; this brought about cost increases.

Also, the transaction terminal may have other functions in addition to the settlement function in order to improve its versatility. When a bar code reader is installed in the transaction terminal, the other functions may include a product bar code reading function, a price look up (PLU) function for functioning as a POS (point of sales) terminal, and a product ordering function.

When the transaction terminal has a plurality of functions including a settlement function in this way, a plurality of application programs for realizing those functions is stored in the ROM 11. Each application program is executed by the CPU 13.

However, when the entire transaction terminal is constituted so as to be tamperproof, it is not possible to add supplementary functions to the transaction terminal, or to add to or modify the application programs in order to update the application programs already included, because it is impossible to access those internal structures. For example, when the case of the transaction terminal is opened, the contents of the ROM 11 are deleted. In that case, it is necessary to replace all of the application programs in the ROM 11. Also, when the internal constitutional elements such as the ROM 11 are covered with resin, it is necessary to replace all of those.

In this way, a conventional transaction terminal apparatus, for executing transactions (for example, settlement transactions) including the processing of secret information such as a customer's personal information, has high costs and is lacking in versatility and expandability because the entire device has a tamperproof structure.

### SUMMARY OF THE INVENTION

It is therefore an object of the present invention to provide a transaction terminal apparatus which has relatively low costs and good versatility and expandability, while ensuring security.

In order to achieve the abovementioned object, the present invention is constituted so that the elements required to be tamperproof, from among the structural elements of the transaction terminal apparatus for executing transaction processing with a customer, are constituted as a module that is removable from the main body of the transaction terminal apparatus and the module is constituted so as to be tamperproof. In this way, the main body of the transaction terminal apparatus does not need to be made tamperproof because the elements required to be tamperproof are made modular and removed from the main body. The application programs relating to various types of transactions stored in the main body can be easily added to, modified, revised, and updated, and the versatility and expandability are improved.

For example, the constitution of the transaction terminal apparatus relating to the present invention and for achieving the abovementioned object is a transaction terminal apparatus for executing the transaction processing with a customer and comprises: a main body; and a module mounted removably on the main body and having a tamperproof constitution; wherein the module comprises an acquiring unit for acquiring secret information relating to the customer and necessary for the transaction processing, and an encrypting unit for encrypting this secret information; and wherein the main body comprises a control unit for receiving secret information encrypted by the encrypting unit, and executing the transaction processing using this secret information.

This secret information includes personal information (card information) stored in the customer's credit card or cash card (bank card), and the personal identification number of the customer. Also, the acquiring unit comprises a card reader (reading unit) for reading the card information and a keyboard (input unit) for inputting the personal identification number.

Furthermore, the present invention is provided a module mounted removably on the main body of the transaction terminal apparatus for executing transaction processing with a customer. This module comprises an acquiring unit for acquiring secret information relating to said customer and necessary for said transaction processing, and an encrypting unit for encrypting this secret information; and is constituted so as to be tamperproof.

### BRIEF DESCRIPTION OF THE DRAWINGS

FIG. 1 is a block diagram of a transaction terminal apparatus relating to an embodiment of the present invention;

FIG. 2 is a flowchart of an example of the settlement processing using the transaction terminal relating to an embodiment of the present invention;

FIG. 3 is an exterior perspective view of the transaction terminal apparatus relating to an embodiment of the present invention;

FIG. 4A and 4B are drawings showing the exterior of the module 2 shown in FIG. 3;

FIG. 5 is a drawing showing another example of the constitution of the module 2;

FIG. 6 is an exterior perspective view of another transaction terminal apparatus relating to an embodiment of the present invention; and

FIG. 7 is a simple block diagram of a conventional transaction terminal apparatus having a settlement function.

### DESCRIPTION OF THE PREFERRED EMBODIMENTS

The embodiments of the present invention are explained below. However, the technical scope of the present invention is not limited by these embodiments.

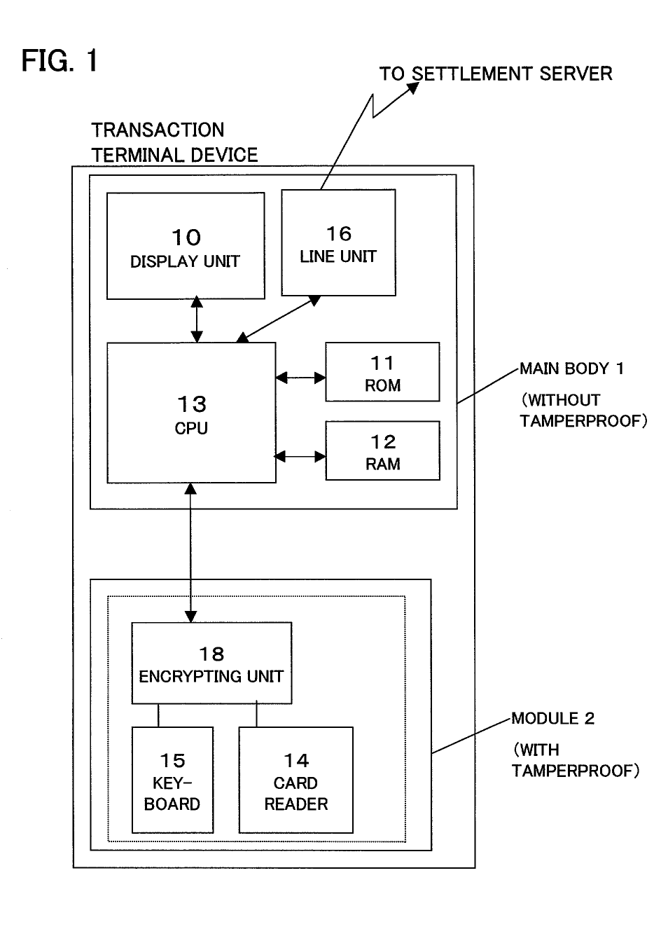

FIG. 1 is a block diagram of the constitution of a transaction terminal apparatus relating to an embodiment of the present invention. The transaction terminal apparatus relating to the present embodiment is illustrated with a portable terminal. Of those constitutional elements within the transaction terminal, only those elements for which tamper-proofing is required are modularized and made removable from the main body of the transaction terminal comprising other elements for which tamper-proofing is not required.

In FIG. 1, the transaction terminal comprises a main body 1 and a module 2 mounted removably thereon. As shown in the drawing, the module 2 comprises a card reader 14 for reading information stored in the transaction media, such as a credit card or cash card (for example, personal information such as the card number; hereinafter referred to sometimes as “card information”); a keyboard (KB) 15 for the customer to input the personal identification number (Personal Identification Number); and an encrypting unit 18 for encrypting the card information read and personal identification number input. Furthermore, the module 2 including these is constituted so as to be tamperproof.

The encrypting unit 18 may also comprise ROM for storing the encryption program, a CPU for executing the program, and RAM for storing temporary data, or may be constituted as an encryption circuit comprising a logic circuit.

Also, to make the constitution of the module 2 tamperproof, the wiring from the card reader 14 and the keyboard 15 loaded on the module 2, and the encrypting unit 18 are affixed with resin, for example. Physical signal theft is thereby prevented and tamper-proofing is ensured. Also, when the encrypting unit 18 is constituted of a CPU, ROM, and RAM, tamper-proofing is ensured by establishing means for destroying data in the ROM and RAM when it is detected by prescribed detecting means that the module 2 is opened.

Meanwhile, the main body 1 comprises a display unit 10 such as liquid crystal, ROM 11 for storing the settlement program and other application programs, RAM 12 for storing temporary data, a CPU 13 for executing the settlement program and other application programs, and a line unit 6 for communicating with a prescribed settlement server through a telecommunications network. Because the decrypting unit 18 is established in the module 2, an encrypting program is not stored in the ROM 11 of the main body 1 and the CPU 13 of the main body 1 does not execute the process to encrypt the card information and personal identification number.

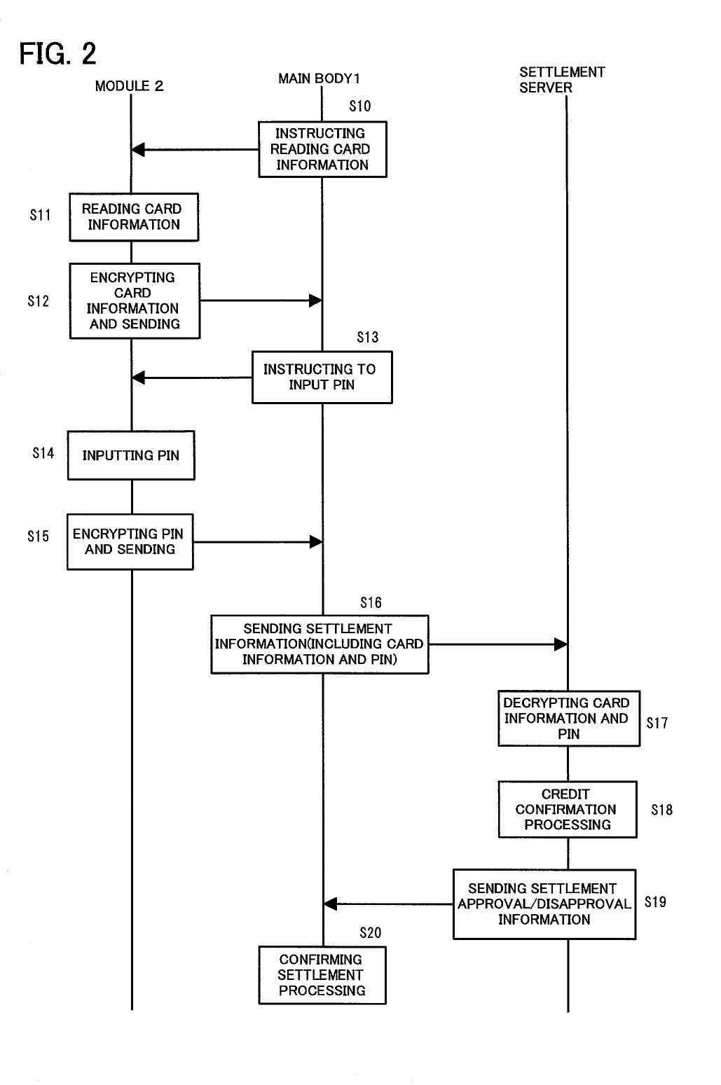

FIG. 2 is a flowchart of an example of the settlement process using the transaction terminal relating to the embodiments of the present invention. Moreover, in this example, the settlement amount (and preferably, the product name (or product number), or the like) is already registered in the CPU 13 of the main body 1 of the transaction terminal. When, for example, the transaction terminal includes a bar code scanner and has a POS (Point of Sales) function, information such as the product name and amount of money can be acquired by scanning the bar code of the item. Even if there is no bar code scanner, product information registered in the transaction terminal or product server (not shown) may also be acquired with a selection operation using the keyboard 15 through the POS function. Even without a POS function, product information such as the product number and the amount of money may also be directly input from the keyboard 15. In FIG. 2, the CPU 13 of the main body 1 commands the reading of the card information when the settlement amount is decided (S10). The command, for example, is displayed on the display unit 10 of the main body 1. With an operation by the store staff entrusted with the card by the customer, the card reader 14 reads the card information (S11). In case of a credit card, the card information is personal information such as the card number. In the case of the cash card, the card information is personal information of the customer minimally including the account number.

Because the card information read is secret information, this information is encrypted by the encrypting unit 18 of the module and sent to the CPU 13 of the main body 1 (S12). The CPU 13 then commands the input of the personal identification number (S13). With this input command, the customer operates the keyboard 15 and input his or her personal identification number (S14).

Because the person identification number input is secret information, this information is encrypted by the encrypting unit 18 of the module and sent to the CPU 13 of the main body 1 (S15).

Upon receiving the encrypted card information and personal identification number, the CPU 13 of the main body 1 sends those and the settlement amount (sometimes these are combined and called “settlement information”) to the settlement server from the line unit 16 through the telecommunications network (S16).

Because the card information and person identification number are processed in an encrypted state after being output from the module 2, the secrecy of the card information and person identification number are maintained even if the main body is not tamperproof. On the telecommunications network as well, because the information is in an encrypted state, the secrecy is likewise maintained even if stolen by another person. Moreover, the settlement server, which is the destination, is different for credit cards and cash cards.

Upon receiving the settlement information, the settlement server decrypts the card information and personal identification number therein (S17) and executes the credit confirmation process (S18). The credit confirmation process minimally includes a process for verifying the personal identification number and a process for approving the settlement amount, and as a result determines whether the settlement is approved. On the basis of the results of the credit confirmation process, the settlement server sends the approval or disapproval information for the settlement to the transaction terminal (S19). At this time, the approval or disapproval information minimally includes the information that the settlement is approved or not approved, and does not include secret information such as the card information or person identification number. The CPU 13 of the main body 1 of the transaction terminal carries out the confirmation of the settlement process according to the approval or disapproval information for the settlement (S20).

In this way, in the present environment, elements for acquiring secret information such as the card information and personal identification number, like the card reader 14 and the keyboard 15, and elements for decrypting the secret information are made into a module, from among the elements constituting the transaction terminal. The entire transaction terminal can be made securely tamperproof by providing that module a tamperproof constitution.

By modularizing the elements for which tamper-proofing is necessary and separating those from the CPU, ROM, and RAM of the main body 1 of the transaction terminal, the main body 1 does not need to be made tamperproof and therefore it becomes possible to add too, modify, revise, and update simply those functions to be executed by the transaction terminal. The versatility and expandability of the transaction terminal is also improved. In other words, the main body 1 can be opened simply; the ROM 11 within the main body 1 can be simply accessed (or the contents stored in the ROM 11 are not destroyed if the main body 1 is opened); and the application programs stored in the ROM 11 can be easily added to, modified, revised, and updated.

Furthermore, for a transaction terminal that does not have a settlement function, meaning a transaction terminal for which tamper-proofing is not necessary, the main body 1 can be commonized by preparing a general module which is not provided tamper-proofing. Specifically, it is possible to switch between a module having tamper-proofing and a module not having tamper-proofing according to the requirements of the settlement function.

Various modules are provided depending on the functions that can be executed by the transaction terminal. By using the modules according to the functions, the main body 1 can be commonized and can be applied to various functions. Also, because the main body 1 can be commonized, this results in reduced costs for the transaction terminal.

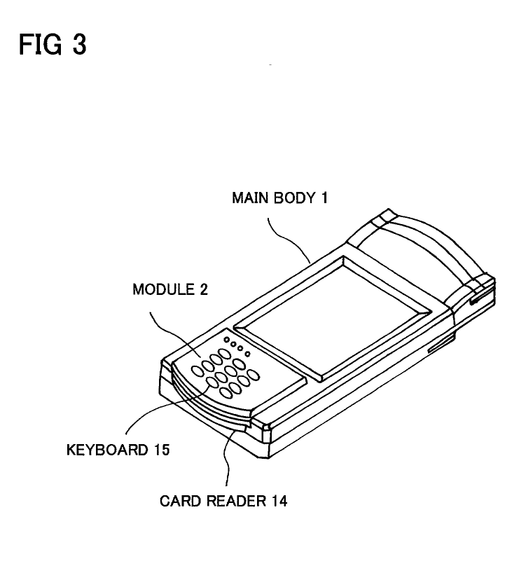

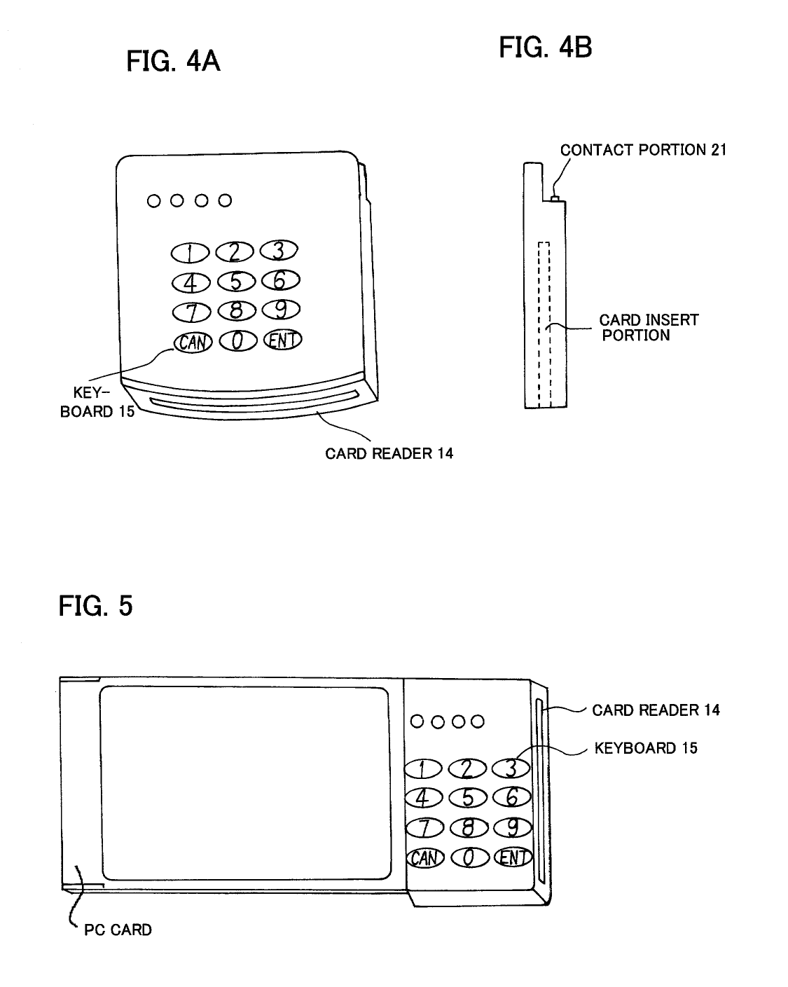

FIG. 3 is an external perspective view of the transaction terminal apparatus relating to an embodiment of the present invention. In FIG. 3, a module including a card reader 14 and a keyboard 15 is mounted removably on the main body 1 which is provided a display unit 10. FIG. 4A and 4B are drawings showing a top view and a side view of the module 2 shown in FIG. 3, respectively. As shown in FIG. 4B, a contact portion (interface) 21 is established on the module 2. Causing this to connect with the contact portion (not shown) established on the main body 1 electrically connects the module 2 and main body 1. The interface between the main body 1 and the module 2 is not limited to an electrical contact and may have other forms. Through the contact portion (interface) of the module 2 and main body 1, information encrypted by the module 2 is sent to the main body 1. Also, a mounting mechanism (not shown) for removably attaching the module 2 to the main body 1 is established.

FIG. 5 is a drawing showing another example of the constitution of the module 2. The module 2 shown in FIG. 5 has a PC card type of constitution. In this case, the main body 1 of the transaction terminal has a PC card slot and the main body 1 of the transaction terminal may also be a general purpose computer device such as a notebook computer, for example.

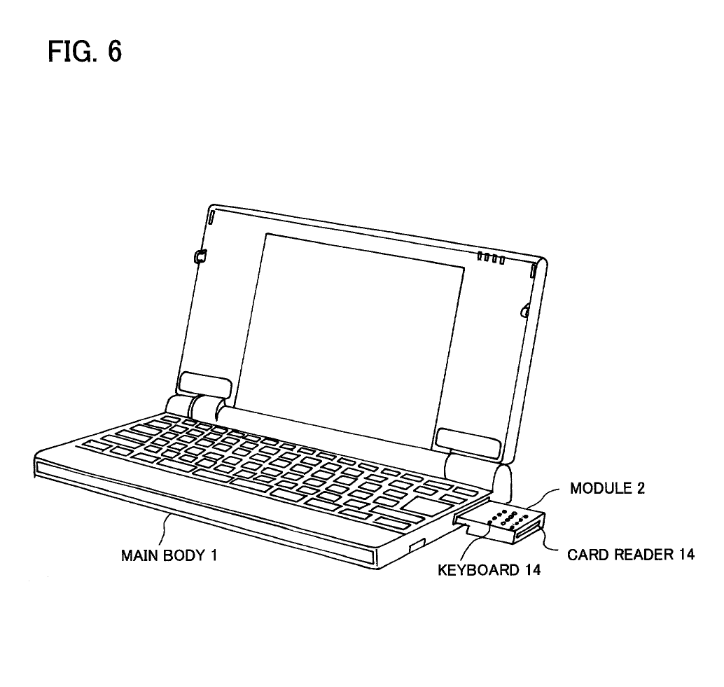

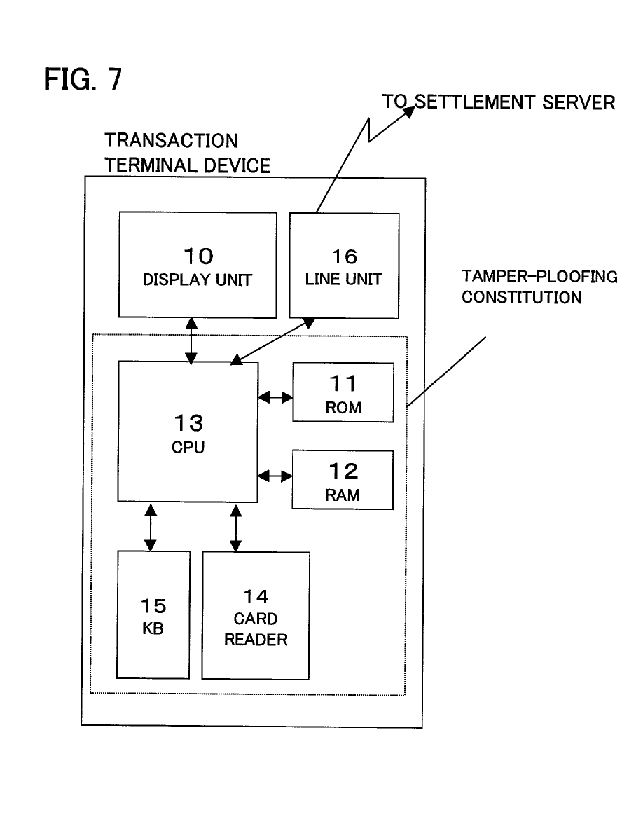

FIG. 6 is an external perspective view of another transaction terminal apparatus relating to an embodiment of the present invention. The transaction terminal apparatus in FIG. 6 has a constitution wherein the module 2 in FIG. 5 is inserted in the main body 1 which is a notebook computer. Specifically, when the module 2 shown in FIG. 5 is inserted in the PC card slot in the main body 1 of the transaction terminal, the module 2 is mounted on the main body 1 so that the card reader 14 and keyboard 15 protrude from the opening of the PC card slot.

In the embodiments of the present invention, a settlement process for handling card information and personal identification numbers was used as an example of the process requiring tamper-proofing. However, processes requiring tamper-proofing are not limited to this and may also be, for example, a process for confirming an account balance at a financial institution using a cash card or a transaction process handling secret information. The present embodiment can be applied to all of the transaction terminal apparatuss for executing transaction processing handling secret information. Also, the transaction terminal apparatus relating to the present invention is not limited to a portable terminal and may also be a stationary terminal apparatus.

Also, the transaction medium storing the customer's personal information is not limited to a credit card or cash card and may also be, for example, a transaction medium in a different form (for example, an IC memory that is not in the form of a card).

With the present invention, elements requiring tamper-proofing, among the elements constituting a transaction terminal apparatus for executing a transaction process with a customer, are constituted as a module which is removable from the main body of the transaction terminal apparatus and the module is constituted so as to be tamperproof. By modularizing elements requiring tamper-proofing and separating them from the main body, it becomes unnecessary to tamperproof the main body of the transaction terminal apparatus. It therefore becomes easy to add to, modify, revise, and update the application programs relating to the various transactions stored in the main body and the versatility and expandability are improved.

For transaction terminals that do not require tamper-proofing, the main body of the transaction terminal apparatus can be commonized and the costs of the transaction terminal apparatus can be lowered by providing modules depending on the type of transaction, such as by preparing a general purpose module that is not tamperproof.

The scope of the present invention is not limited to the abovementioned embodiments and extends to inventions within the scope of the claims and items equivalent thereto.

What is claimed is:

1. A transaction terminal apparatus for executing transaction processing with a customer, comprising:
a main body; and
a module mounted removably on the main body and constituted so as to be tamperproof;
wherein said module comprises an acquiring unit for acquiring secret information relating to said customer necessary for said transaction processing, and an encrypting unit for encrypting the secret information; and
wherein said main body comprises a control unit for receiving the secret information encrypted by said decrypting unit and executing said transaction processing using this secret information.

2. The transaction terminal apparatus, according to claim 1, wherein said secret information comprises personal information of said customer; and said acquiring unit comprises a reading unit for reading the personal information from a transaction medium storing said personal information of the customer.

3. The transaction terminal apparatus, according to claim 1, wherein said secret information comprises the personal identification number of said customer, and said acquiring unit comprises an input unit for inputting said personal identification number.

4. The transaction terminal apparatus, according to claim 1, wherein the transaction process executed by said control unit comprises:
a first process for sending said secret information in an encrypted state to a prescribed server through a telecommunications network; and
a second process for receiving, from said server and through said telecommunications network, information on the results of a decrypting process for said secret information and a prescribed credit confirmation process based on the decrypted secret information executed by the server.

5. A module mounted removably on the main body of a transaction terminal apparatus for executing transaction processing with a customer, comprising:
an acquiring unit for acquiring secret information relating to said customer necessary for said transaction processing; and
an encrypting unit for encrypting this secret information;
wherein said module is constituted so as to be tamperproof.

6. The module according to claim 5, wherein said secret information comprises personal information of said customer; and said acquiring unit comprises a reading unit for reading the personal information from the transaction medium storing said personal information of the customer.

7. The module according to claim 5, wherein said secret information comprises the personal identification number of said customer; and said acquiring unit comprises an input unit for inputting said personal identification number.

8. A module mounted removably on the main body of a transaction terminal apparatus for executing transaction processing with a customer, comprising:
an input unit for inputting data relating to said customer necessary for said transaction processing;
a reading unit for reading the data from a transaction medium storing data relating to said customer, necessary for said transaction processing;
an encrypting unit for encrypting data input from said input unit and data read by said reading unit; and
an interface for sending the encrypted data to said main body;
wherein the module is constituted so as to be tamperproof.
